(19) United States
(12) Patent Application Publication
(10) Pub. No.: US 2026/0225549 A1
(43) Pub. Date: Aug. 6, 2026

(54) IN-VEHICLE INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Naoki KOSAKA, Ota-ku (JP); Junichiro TAMAO, Sumida-ku (JP); Ryoko WADA, Kawasaki-shi (JP); Masaaki KUZUYA, Shinagawa-ku (JP); Takumi HORIE, Yokohama-shi (JP)

(73) Assignee: TOYOTA JIDOSHA KABUSHIKI KAISHA, Toyota-shi (JP)

(21) Appl. No.: 19/442,563

(22) Filed: Jan. 7, 2026

(30) Foreign Application Priority Data
Feb. 5, 2025 (JP) 2025-017952

(51) Int. Cl. B60R 16/037

(52) U.S. Cl. CPC B60R 16/0373

(57) ABSTRACT

An in-vehicle information processing device includes a processor. The processor activates a plurality of VUI functions with an identical activation phrase. The VUI functions are linked to respective in-vehicle functions. The VUI functions each perform a speech recognition process on an utterance by a user to recognize a voice command for an in-vehicle function and execute the in-vehicle function based on the voice command. In a case where a predetermined in-vehicle function is activated, the processor activates a VUI function linked to the in-vehicle function and, even during activation of the VUI function, allows a different VUI function to perform predetermined operation.

### CROSS-REFERENCE TO RELATED APPLICATION

This application claims priority to Japanese Patent Application No. 2025-017952 filed on February 5, 2025. The disclosure of the above-identified application, including the specification, drawings, and claims, is incorporated by reference herein in its entirety.

### BACKGROUND

### 1. Technical Field

The present disclosure relates to an in-vehicle information processing device, an information processing method, and a non-transitory storage medium.

### 2. Description of Related Art

Techniques relating to voice interaction services in vehicles are known. For example, Japanese Unexamined Patent Application Publication No. 2020-144275 (JP 2020-144275 A) discloses an agent device including: a plurality of agent function units that provides a service including making a voice response in response to an utterance by an occupant of a vehicle; and a management unit that, when the occupant of the vehicle utters a first activation phrase that is individually set for each of the agent function units, activates one of the agent function units that corresponds to the uttered first activation phrase and, when the occupant of the vehicle utters a second activation phrase that is commonly set for two or more of the agent function units, activates the two or more agent function units that correspond to the uttered second activation phrase.

### SUMMARY

However, when a plurality of VUI (Voice User Interface) functions is provided, a user needs to have the knowledge of combinations of activation phrases and VUI functions linked to the activation phrases. Furthermore, when the number of the VUI functions increases, it becomes difficult for the user to remember all the activation words for agent functions. To address this issue, it is conceivable to use a common activation phrase for the VUI functions. When the VUI functions respond individually in that case, however, the resource utilization efficiency is reduced.

The present disclosure provides an in-vehicle information processing device, an information processing method, and a non-transitory storage medium that improve the resource utilization efficiency while using a common activation word for VUI functions.

A first aspect of the present disclosure provides an in-vehicle information processing device including a processor. The processor activates a plurality of VUI functions with an identical activation phrase. The VUI functions are linked to respective in-vehicle functions, and the VUI functions each perform a speech recognition process on an utterance by a user to recognize a voice command for an in-vehicle function and execute the in-vehicle function based on the voice command. In a case where a predetermined in-vehicle function is activated, the processor activates a VUI function linked to the in-vehicle function and, even during activation of the VUI function, allows a different VUI function to perform predetermined operation.

A second aspect of the present disclosure provides an in-vehicle information processing device including a processor. The processor activates a plurality of VUI functions with an identical activation phrase. The VUI functions are linked to respective in-vehicle functions. In a case where a predetermined in-vehicle function is activated, the processor activates a VUI function linked to the in-vehicle function and, even during activation of the VUI function, allows a different VUI function to perform predetermined operation.

In the in-vehicle information processing device according to the second aspect of the present disclosure, the processor may be configured to, in a case where the VUI function does not have a right of access to an operation requested through a voice command, input the voice command to the different VUI function.

In the in-vehicle information processing device according to the second aspect of the present disclosure, the processor may be configured to activate all of the VUI functions in a case where the in-vehicle information processing device is activated.

In the in-vehicle information processing device according to the second aspect of the present disclosure, the processor may be configured to, in a case where the predetermined in-vehicle function is activated, increase priority of activation phrase recognition authority of a VUI function linked to the in-vehicle function.

In the in-vehicle information processing device according to the second aspect of the present disclosure, the processor may be configured to, in a case where the predetermined in-vehicle function is terminated, lower priority of activation phrase recognition authority of a VUI function linked to the in-vehicle function.

In the in-vehicle information processing device according to the second aspect of the present disclosure, the processor may be configured to, in a case where a VUI function that has been given activation phrase recognition authority does not have highest priority of the activation phrase recognition authority, revoke the activation phrase recognition authority from the VUI function and give the activation phrase recognition authority to a different VUI function with the highest priority.

In the in-vehicle information processing device according to the second aspect of the present disclosure, the processor may be configured to initialize priority of activation phrase recognition authority of the VUI functions in a case where the in-vehicle information processing device is activated.

A third aspect of the present disclosure provides an information processing method executed by an in-vehicle information processing device having a plurality of VUI functions to be activated with an identical activation phrase. The VUI functions are linked to respective in-vehicle functions. The information processing method includes: performing a speech recognition process on an utterance by a user to recognize a voice command for an in-vehicle function and execute the in-vehicle function based on the voice command; and in a case where a predetermined in-vehicle function is activated, activating a VUI function linked to the in-vehicle function and, even during activation of the VUI function, allowing a different VUI function to perform predetermined operation.

A fourth aspect of the present disclosure provides an information processing method executed by an in-vehicle information processing device having a plurality of VUI functions to be activated with an identical activation phrase. The VUI functions are linked to respective in-vehicle functions. The information processing method includes, in a case where a predetermined in-vehicle function is activated, activating a VUI function linked to the in-vehicle function and, even during activation of the VUI function, allowing a different VUI function to perform predetermined operation.

The information processing method according to the fourth aspect of the present disclosure may further include, in a case where the VUI function does not have a right of access to an operation requested through a voice command, inputting the voice command to the different VUI function.

The information processing method according to the fourth aspect of the present disclosure may further include activating all of the VUI functions in a case where the in-vehicle information processing device is activated.

The information processing method according to the fourth aspect of the present disclosure may further include, in a case where the predetermined in-vehicle function is activated, increasing priority of activation phrase recognition authority of a VUI function linked to the in-vehicle function.

The information processing method according to the fourth aspect of the present disclosure may further include, in a case where the predetermined in-vehicle function is terminated, lowering priority of activation phrase recognition authority of a VUI function linked to the in-vehicle function.

The information processing method according to the fourth aspect of the present disclosure may further include, in a case where a VUI function that has been given activation phrase recognition authority does not have highest priority of the activation phrase recognition authority, revoking the activation phrase recognition authority from the VUI function and giving the activation phrase recognition authority to a different VUI function with the highest priority.

The information processing method according to the fourth aspect of the present disclosure may further include initializing priority of activation phrase recognition authority of the VUI functions in a case where the in-vehicle information processing device is activated.

A fifth aspect of the present disclosure provides a non-transitory storage medium storing instructions that are executable by one or more processors and cause the one or more processors to execute a function. The processors have a plurality of VUI functions to be activated with an identical activation phrase. The VUI functions are linked to respective in-vehicle functions. The function includes: performing a speech recognition process on an utterance by a user to recognize a voice command for an in-vehicle function and execute the in-vehicle function based on the voice command; and in a case where a predetermined in-vehicle function is activated, activating a VUI function linked to the in-vehicle function and, even during activation of the VUI function, allowing a different VUI function to perform predetermined operation.

A sixth aspect of the present disclosure provides a non-transitory storage medium storing instructions that are executable by one or more processors and cause the one or more processors to execute a function. The processors have a plurality of VUI functions to be activated with an identical activation phrase. The VUI functions are linked to respective in-vehicle functions. The function includes, in a case where a predetermined in-vehicle function is activated, activating a VUI function linked to the in-vehicle function and, even during activation of the VUI function, allowing a different VUI function to perform predetermined operation.

In the non-transitory storage medium according to the sixth aspect of the present disclosure, the function may further include, in a case where the VUI function does not have a right of access to an operation requested through a voice command, inputting the voice command to the different VUI function.

In the non-transitory storage medium according to the sixth aspect of the present disclosure, the function may further include, in a case where the predetermined in-vehicle function is activated, increasing priority of activation phrase recognition authority of a VUI function linked to the in-vehicle function.

According to the first aspect of the present disclosure, it is possible to improve the resource utilization efficiency while using a common activation word for VUI functions.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates a schematic configuration of an in-vehicle information processing device according to a first embodiment of the present disclosure;

FIG. 2 is a first flowchart illustrating an example of operation of the in-vehicle information processing device according to the first embodiment of the present disclosure;

FIG. 3 illustrates the priority of VUI functions during the operation illustrated in FIG. 2;

FIG. 4 is a second flowchart illustrating an example of operation of the in-vehicle information processing device according to the first embodiment of the present disclosure;

FIG. 5 illustrates a plurality of in-vehicle functions activated by the in-vehicle information processing device according to the first embodiment of the present disclosure;

FIG. 6 is a third flowchart illustrating an example of operation of the in-vehicle information processing device according to the first embodiment of the present disclosure;

FIG. 7 illustrates the priority of VUI functions during the operation illustrated in FIG. 6;

FIG. 8 is a fourth flowchart illustrating an example of operation of the in-vehicle information processing device according to the first embodiment of the present disclosure;

FIG. 9 illustrates a schematic configuration of an in-vehicle information processing device according to a second embodiment of the present disclosure;

FIG. 10 is a first flowchart illustrating an example of operation of the in-vehicle information processing device according to the second embodiment of the present disclosure;

FIG. 11 illustrates the priority of VUI functions during the operation illustrated in FIG. 10;

FIG. 12 is a second flowchart illustrating an example of operation of the in-vehicle information processing device according to the second embodiment of the present disclosure; and

FIG. 13 illustrates the priority of VUI functions during the operation illustrated in FIG. 12.

### DETAILED DESCRIPTION OF EMBODIMENTS

Embodiments of the present disclosure will be described in detail below with reference to the drawings.

### First Embodiment

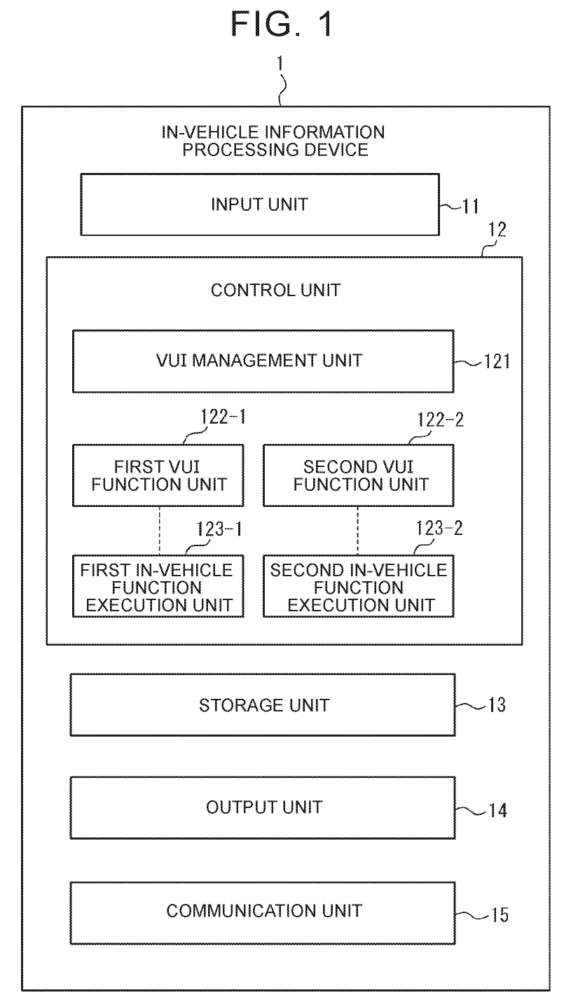

The configuration of an in-vehicle information processing device according to a first embodiment will be described with reference to FIG. 1. The in-vehicle information processing device 1 illustrated in FIG. 1 includes an input unit 11, a control unit 12, a storage unit 13, an output unit 14, and a communication unit 15.

The in-vehicle information processing device 1 is a multimedia device mounted on a vehicle and has a plurality of in-vehicle functions. The in-vehicle functions may include, for example, a navigation function, an audio function such as radio and television, an information transmission function such as news and weather, a vehicle association function for communicating with other vehicles, and an association function for communicating with smart devices (for example, smartphones). The in-vehicle functions may also include functions for operating equipment of a vehicle such as air conditioning, windows, wipers, lights, roof, and shades. The in-vehicle information processing device 1 has a plurality of VUI (Voice User Interface) functions that are activated with an identical activation phrase (Wake-Up Word). The VUI functions are linked to the in-vehicle functions. When a predetermined in-vehicle function (typically the navigation function) is activated, the VUI function linked to the predetermined in-vehicle function is activated. Even during the activation of the VUI, however, other VUI functions perform predetermined operation. The activation phrase may be, but is not limited to, "Hey Toyota!", for example. The activation phrase may be changeable by a user through settings.

The input unit 11 includes one microphone that picks up an utterance by an occupant of the vehicle. The input unit 11 may also include a physical key, a capacitance key, a touch panel, or the like that receives input from the user of the in-vehicle information processing device 1.

The storage unit 13 includes at least one semiconductor memory, at least one magnetic memory, at least one optical memory, or any combination of these. The semiconductor memory is a random access memory (RAM), a read only memory (ROM), or a flash memory, for example. The storage unit 13 functions as a main storage device, an auxiliary storage device, or a cache memory, for example. The storage unit 13 stores information to be used in the operation of the in-vehicle information processing device 1 and information obtained by the operation of the in-vehicle information processing device 1.

The output unit 14 includes at least one output interface. The output interface may be a display that outputs an image prepared by the control unit 12. The output interface may also be a speaker that outputs a sound prepared by the control unit 12. The input unit 11 and the output unit 14 may be integrated into one unit such as a touch screen.

The communication unit 15 includes at least one communication interface for communicating with external devices such as a server and sensors. In the case of wired communication, the communication interface may be a Local Area Network (LAN) interface or an interface that supports a communication standard such as Universal Serial Bus (USB), for example. In the case of wireless communication, the communication interface may be an interface that supports a mobile communication standard such as LTE (Long Term Evolution), 4G (4th generation), or 5G (5th generation), or an interface that supports short-range wireless communication such as Bluetooth, for example. The communication unit 15 transmits information prepared by the control unit 12 to the external devices. The communication unit 15 outputs information received from the external devices to the storage unit 13.

The control unit 12 includes at least one processor, at least one programmable circuit, at least one dedicated circuit, or any combination of these. The processor is a general-purpose processor such as a central processing unit (CPU) or a graphics processing unit (GPU), or a dedicated processor specialized for a specific process. The programmable circuit is, for example, a field-programmable gate array (FPGA). The dedicated circuit is, for example, an application specific integrated circuit (ASIC). The control unit 12 executes processes related to the operation of the in-vehicle information processing device 1 while controlling the various units of the in-vehicle information processing device 1.

The control unit 12 includes a VUI management unit 121, N VUI function units 122-k (1 ≤ k ≤ N), and N in-vehicle function execution units 123-k (1 ≤ k ≤ N). Here, N is the number of VUIs and is an integer of 2 or more. In FIG. 1, the number of VUIs is determined as N = 2, a first VUI function unit 122-1 and a second VUI function unit 122-2 are illustrated as the VUI function units 122-k, and a first in-vehicle function execution unit 123-1 and a second in-vehicle function execution unit 123-2 are illustrated as the in-vehicle function execution units 123-k. The VUI function units 122-k and the in-vehicle function execution units 123-k may all be manufactured in-house, or some may be manufactured in-house and the rest may be manufactured by other companies (third parties).

The VUI management unit 121 controls the activation (ON)/termination (OFF) of the VUI function units 122-k. Furthermore, the VUI management unit 121 determines the priority of activation phrase recognition authority (authority to recognize the activation phrase) for each of the VUI function units 122-k. The VUI management unit 121 gives activation phrase recognition authority to the VUI function unit 122-k with the highest priority (hereinafter occasionally referred to simply as "priority") of activation phrase recognition authority. The VUI function unit 122-k having the activation phrase recognition authority has authority to recognize an utterance by the user that follows the activation phrase. The priority may be stored in the storage unit 13.

The VUI function units 122-k are activated with an identical activation phrase. The VUI function units 122-k are linked to (associated with) the respective in-vehicle functions. For example, it is assumed that a first in-vehicle function is linked to the first VUI function unit 122-1, and a second in-vehicle function is linked to the second VUI function unit 122-2. In this case, when the first in-vehicle function is activated, the first VUI function unit 122-1 linked to the first in-vehicle function is activated, but the second VUI function unit 122-2 performs predetermined operation even during the activation of the first VUI function unit 122-1. Similarly, when the second in-vehicle function is activated, the second VUI function unit 122-2 linked to the second in-vehicle function is activated, but the first VUI function unit 122-1 performs predetermined operation even during the activation of the second VUI function unit 122-2.

The VUI function unit 122-k interacts with the user and performs agent processing such as a speech recognition process and a natural language process. When the VUI function unit 122-k recognizes a command (voice command) from the user for an in-vehicle function, the VUI function unit 122-k outputs the voice command to the in-vehicle function execution unit 123-k, thereby causing the in-vehicle function execution unit 123-k to execute the in-vehicle function linked to the VUI function unit 122-k. The speech recognition process may include, as preprocessing, a noise reduction process for removing background noise and the like contained in an audio signal. The VUI function unit 122-k may perform the speech recognition process and the natural language process by utilizing Artificial Intelligence (AI). For example, the VUI function unit 122-k extracts phonemes using an acoustic model and understands the context using a language model such as a Hidden Markov Model (HMM) or an N-gram. The VUI function unit 122-k may use not only a Deep Neural Network–Hidden Markov Model (DNN-HMM) model but also known models such as an End-to-End model.

The in-vehicle function execution unit 123-k executes an in-vehicle function linked to the VUI function unit 122-k based on a voice command input from the VUI function unit 122-k. The in-vehicle function execution unit 123-k may execute an in-vehicle function linked to the VUI function unit 122-k based on an operation command input by the user operating the input unit 11. That is, the first in-vehicle function execution unit 123-1 executes the in-vehicle function linked to the first VUI function unit 122-1, and the second in-vehicle function execution unit 123-2 executes the in-vehicle function linked to the second VUI function unit 122-2. The number of in-vehicle functions linked to the VUI function unit 122-k may be one or more. For example, the in-vehicle function linked to the first VUI function unit 122-1 may be a navigation application made in-house, and the in-vehicle function linked to the second VUI function unit 122-2 may be a navigation application made by another company. For example, the in-vehicle function linked to the first VUI function unit 122-1 may include an in-vehicle function that significantly affects the safety of the vehicle, and the in-vehicle function linked to the second VUI function unit 122-2 may include an in-vehicle function that does not significantly affect the safety of the vehicle and an in-vehicle function made by another company.

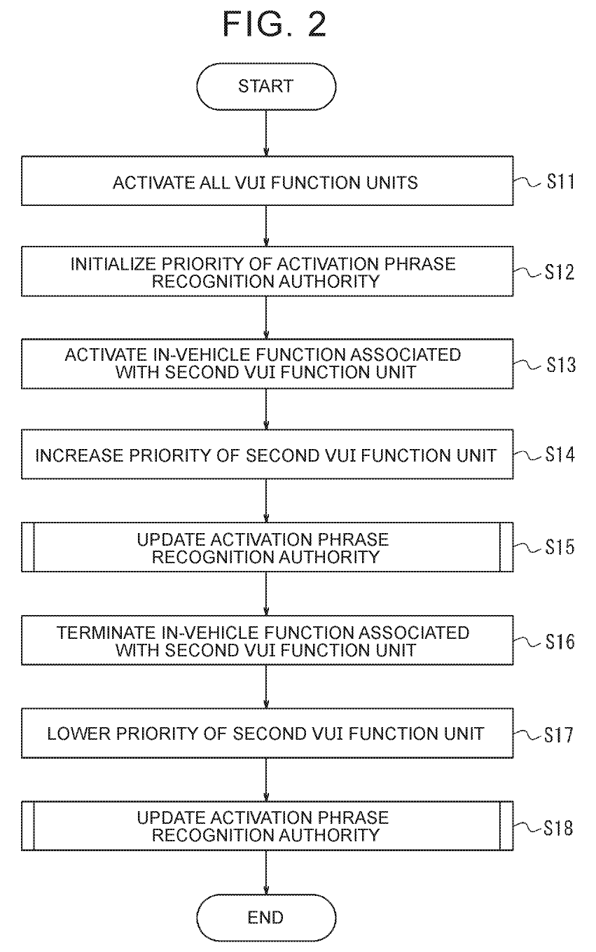

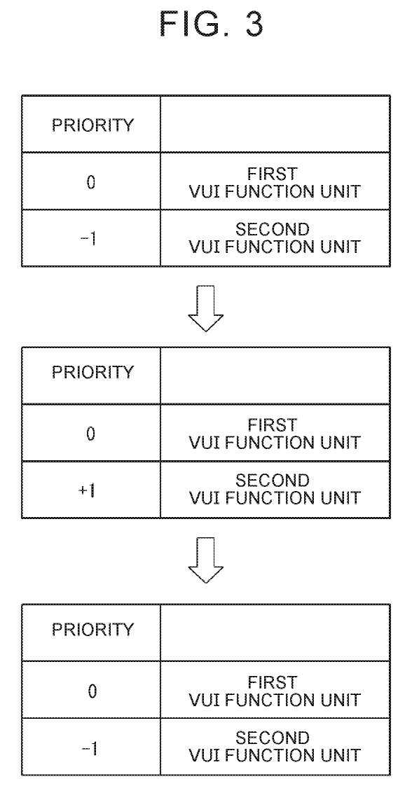

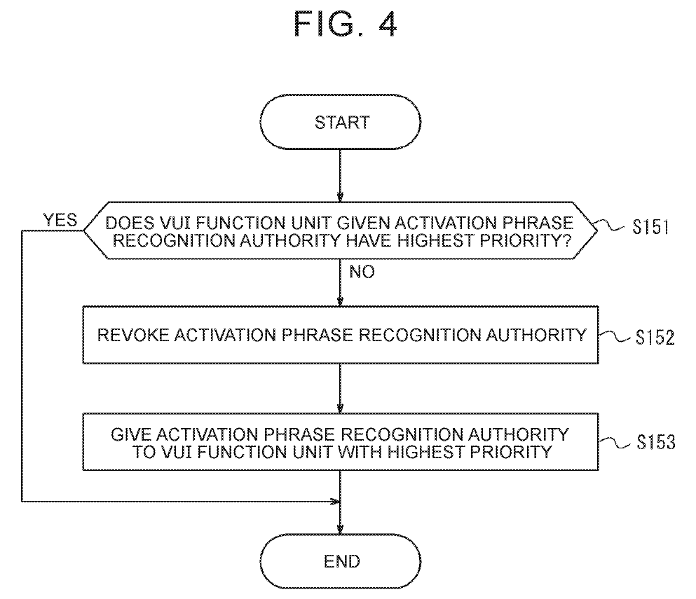

Next, an example of the operation of the control unit 12 of the in-vehicle information processing device 1 according to the first embodiment will be described with reference to FIGS. 2 to 4. In this example, it is assumed that there is one in-vehicle function linked to the second VUI function unit 122-2. FIG. 2 is a flowchart illustrating an example of operation for a case where the user activates an in-vehicle function linked to the second VUI function unit 122-2 between the activation and the termination of the in-vehicle information processing device 1. FIG. 3 illustrates the priority of the VUI function unit 122-k during the operation illustrated in FIG. 2. FIG. 4 is a flowchart illustrating the operation to update activation phrase recognition authority.

In S11, when the in-vehicle information processing device 1 is activated, the VUI management unit 121 activates all the VUI function units 122-k. In the present embodiment, the VUI management unit 121 activates the first VUI function unit 122-1 and the second VUI function unit 122-2. At this point, no in-vehicle functions are activated.

In S12, the VUI management unit 121 initializes the priority of activation phrase recognition authority. The priority at the time of initialization may be determined in advance or may be changeable by the user. For example, as indicated in FIG. 3, the priority of the first VUI function unit 122-1 is set to "0" and the priority of the second VUI function unit 122-2 is set to "–1." In the following description, it is assumed that the priority is higher as the value is larger. Furthermore, the priority is not limited to the values indicated in the drawing. In the example indicated in FIG. 3, the first VUI function unit 122-1 is given the highest priority at the time of initialization. The VUI management unit 121 also initializes the activation phrase recognition authority. The activation phrase recognition authority at the time of initialization may be determined in advance or may be changeable by the user. Here, the following operation will be described on the assumption that the VUI management unit 121 has given the activation phrase recognition authority to the first VUI function unit 122-1.

In S13, it is assumed that the user of the in-vehicle information processing device 1 inputs an instruction to activate an in-vehicle function linked to (associated with) the second VUI function unit 122-2 by operating the input unit 11 (for example, touching an icon on the touch screen). Then, the second in-vehicle function execution unit 123-2 activates the in-vehicle function based on the instruction by the user.

In S14, the VUI management unit 121 sets the priority of the second VUI function unit 122-2 to be higher than the priority of the first VUI function unit 122-1. For example, as indicated in FIG. 3, the priority of the second VUI function unit 122-2 is increased from "–1" to "+1".

In S15, the VUI management unit 121 updates the activation phrase recognition authority. The operation to update the activation phrase recognition authority will be described with reference to FIG. 4.

In S151, the VUI management unit 121 determines whether the VUI function unit 122-k that has been given the activation phrase recognition authority has the highest priority. When the VUI function unit 122-k that has been given the activation phrase recognition authority has the highest priority, the VUI management unit 121 terminates the operation to update the activation phrase recognition authority. When the VUI function unit 122-k that has been given the activation phrase recognition authority does not have the highest priority, the VUI management unit 121 advances the process to S152. In the initial state, the activation phrase recognition authority is given to the first VUI function unit 122-1. In the present embodiment, the priority of the first VUI function unit 122-1, "0", is lower than the priority of the second VUI function unit 122-2, "+1", and therefore the VUI management unit 121 advances the process to S152.

In S152, the VUI management unit 121 revokes the activation phrase recognition authority from the VUI function unit 122 that has been given the activation phrase recognition authority. In the example illustrated in FIG. 2, the VUI management unit 121 revokes the activation phrase recognition authority from the first VUI function unit 122-1 that has been given the activation phrase recognition authority.

In S153, the VUI management unit 121 gives the activation phrase recognition authority to the VUI function unit 122-k with the highest priority. In the example illustrated in FIG. 2, the VUI management unit 121 gives the activation phrase recognition authority to the second VUI function unit 122-2 with the highest priority.

Reference is again made to FIG. 2. In S16, it is assumed that the user of the in-vehicle information processing device 1 inputs an instruction to terminate the in-vehicle function linked to the second VUI function unit 122-2 by operating the input unit 11. Then, the second in-vehicle function execution unit 123-2 terminates the in-vehicle function based on the instruction by the user.

In S17, the VUI management unit 121 sets the priority of the second VUI function unit 122-2 to be lower than the priority of the first VUI function unit 122-1. For example, as indicated in FIG. 3, the priority of the second VUI function unit 122-2 is lowered from "+1" to "–1."

In S18, the VUI management unit 121 performs the same process as in S15 again. In the example illustrated in FIGS. 2 and 3, at this point, the second VUI function unit 122-2 has been given the activation phrase recognition authority, and the first VUI function unit 122-1 has the highest priority (No in S151). Thus, the VUI management unit 121 revokes the activation phrase recognition authority from the second VUI function unit 122-2 (S152). Then, the VUI management unit 121 gives the activation phrase recognition authority to the first VUI function unit 122-1 with the highest priority (S153).

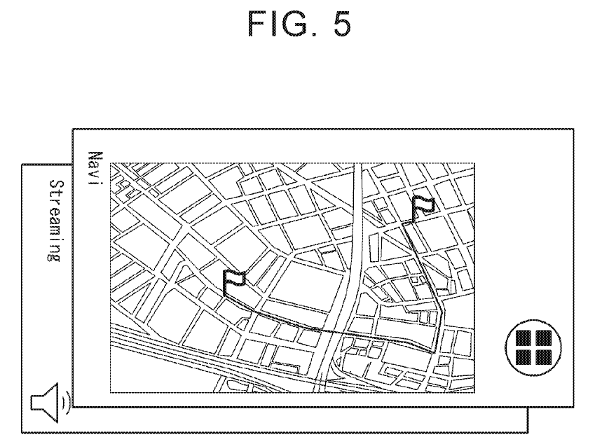

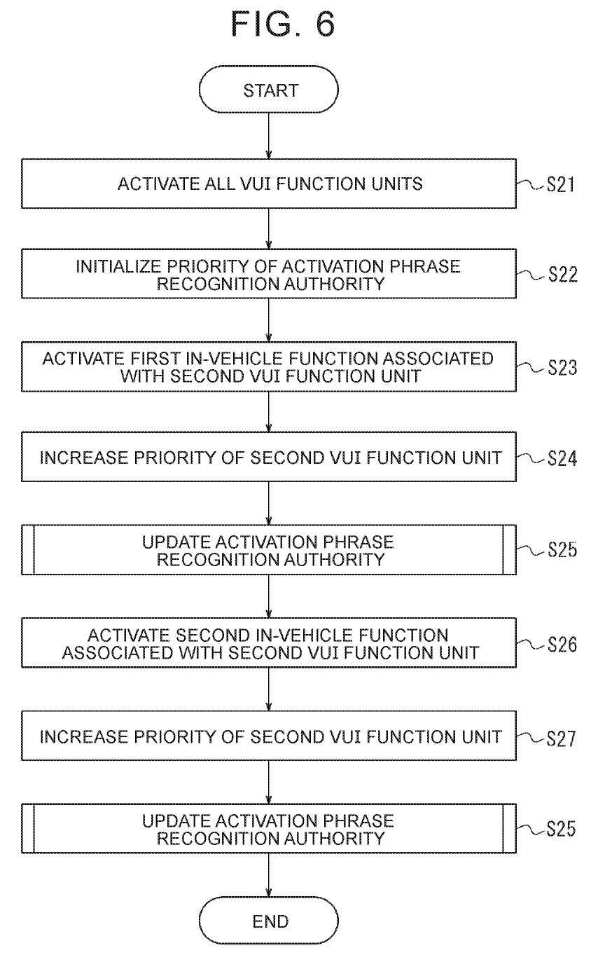

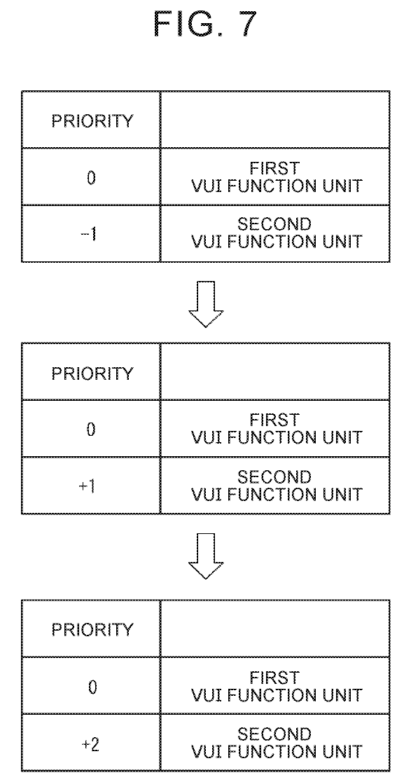

In FIG. 2, it is assumed that only one in-vehicle function linked to the second VUI function unit 122-2 is activated. However, a plurality of in-vehicle functions linked to the VUI function unit 122-k may be activated at the same time. For example, as illustrated in FIG. 5, the in-vehicle function linked to the second VUI function unit 122-2 may include a navigation application and an audio application that plays audio (streaming) in the background of the navigation application, and the navigation application and the audio application may be activated at the same time. Furthermore, the VUI management unit 121 may change the weight of the priority of the in-vehicle function. The process in this case will be described with reference to FIGS. 6 and 7.

FIG. 6 is a flowchart illustrating an example of operation to update the activation phrase recognition authority when the user activates two in-vehicle functions linked to the second VUI function unit 122-2 after the activation of the in-vehicle information processing device 1. FIG. 7 illustrates the priority of the VUI function unit 122-k during the operation illustrated in FIG. 6.

In S21, when the in-vehicle information processing device 1 is activated, the VUI management unit 121 activates the first VUI function unit 122-1 and the second VUI function unit 122-2.

In S22, the VUI management unit 121 initializes the priority of activation phrase recognition authority. For example, as indicated in FIG. 7, the priority of the first VUI function unit 122-1 is set to "0" and the priority of the second VUI function unit 122-2 is set to "–1." That is, in the example indicated in FIG. 7, the first VUI function unit 122-1 is given the highest priority at the time of initialization. The VUI management unit 121 also initializes the activation phrase recognition authority. Here, the following operation will be described on the assumption that the VUI management unit 121 has given the activation phrase recognition authority to the first VUI function unit 122-1.

In S23, it is assumed that the user of the in-vehicle information processing device 1 inputs an instruction to activate a first in-vehicle function (for example, a navigation application) linked to the second VUI function unit 122-2 by operating the input unit 11. Then, the second in-vehicle function execution unit 123-2 activates the first in-vehicle function based on the instruction by the user.

In S24, the VUI management unit 121 sets the priority of the second VUI function unit 122-2 to be higher than the priority of the first VUI function unit 122-1. For example, as indicated in FIG. 7, the priority of the second VUI function unit 122-2 is increased from "–1" to "+1".

In S25, the VUI management unit 121 updates the activation phrase recognition authority. The process in S25 is the same as the process in S15 illustrated in FIG. 4. In the example illustrated in FIGS. 6 and 7, at this point, the first VUI function unit 122-1 has been given the activation phrase recognition authority, and the second VUI function unit 122-2 has the highest priority (No in S151). Thus, the VUI management unit 121 revokes the activation phrase recognition authority from the first VUI function unit 122-1 (S152). Then, the VUI management unit 121 gives the activation phrase recognition authority to the second VUI function unit 122-2 with the highest priority (S153).

In S26, it is assumed that the user of the in-vehicle information processing device 1 inputs an instruction to activate a second in-vehicle function (for example, an audio application) linked to the second VUI function unit 122-2 by operating the input unit 11. Then, the second in-vehicle function execution unit 123-2 activates the second in-vehicle function based on the instruction by the user. Alternatively, when the user of the in-vehicle information processing device 1 makes an instruction to activate the first in-vehicle function linked to the second VUI function unit 122-2 (S23), the second in-vehicle function execution unit 123-2 may automatically activate the second in-vehicle function subsequent to the activation of the first in-vehicle function.

In S27, the VUI management unit 121 sets the priority of the second VUI function unit 122-2 to be even higher. For example, as indicated in FIG. 7, the priority of the second VUI function unit 122-2 is increased from "+1" to "+2".

After S27, the VUI management unit 121 performs the same process as in S25 (S15) again. In the example illustrated in FIGS. 6 and 7, at this point, the second VUI function unit 122-2 has been given the activation phrase recognition authority, and the second VUI function unit 122-2 has the highest priority (Yes in S151). Thus, the VUI management unit 121 maintains the activation phrase recognition authority being given to the second VUI function unit 122-2.

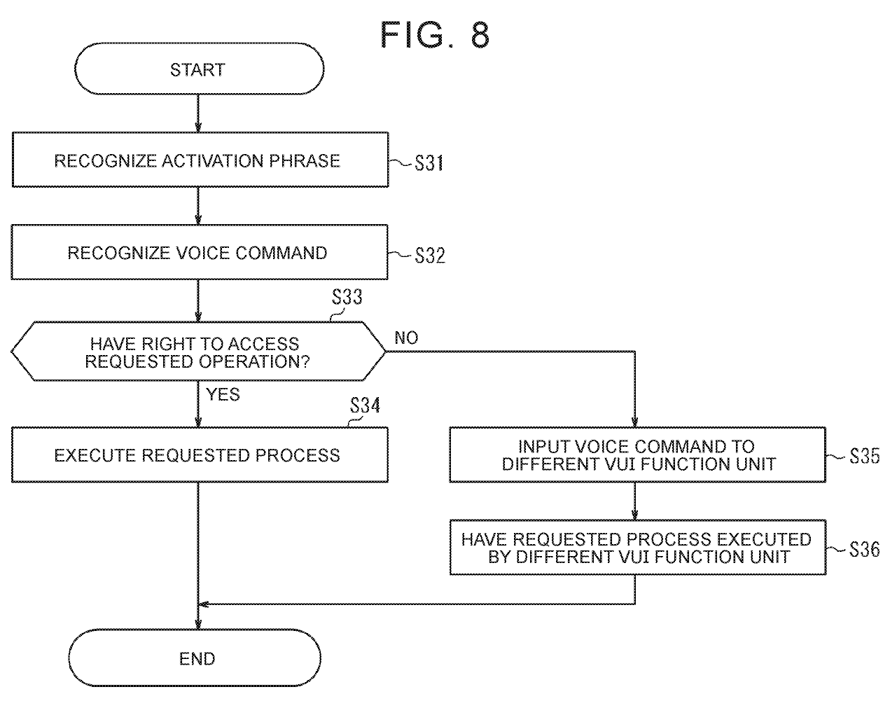

Next, an example in which a different VUI function performs predetermined operation during the activation of a certain VUI function will be described. FIG. 8 is a flowchart illustrating an example of operation for a case where the user makes an instruction to operate an in-vehicle function linked to the first VUI function unit 122-1 when an in-vehicle function linked to the second VUI function unit 122-2 is activated. Here, it is assumed that the processes in S11 to S15 indicated in FIG. 2 have been performed. Thus, the first VUI function unit 122-1 and the second VUI function unit 122-2 are activated. Moreover, the second VUI function unit 122-2 has the highest priority.

In S31, the second VUI function unit 122-2 with the highest priority recognizes an activation phrase uttered by the user.

In S32, the second VUI function unit 122-2 recognizes a voice command uttered by the user following the activation phrase.

In S33, the second VUI function unit 122-2 checks whether the second VUI function unit 122-2 has the right of access to an operation requested through the voice command. When the second VUI function unit 122-2 has the right of access to the requested operation, the second VUI function unit 122-2 advances the process to S34. When the second VUI function unit 122-2 does not have the right of access to the requested operation, the second VUI function unit 122-2 advances the process to S35.

In S34, the second in-vehicle function execution unit 123-2 executes the operation requested through the voice command.

In S35, the second VUI function unit 122-2 inputs (transfers) the recognized voice command to the first VUI function unit 122-1. Alternatively, the second VUI function unit 122-2 may notify the VUI management unit 121 of the voice command and that the second VUI function unit 122-2 does not have the right of access to the requested operation, and the VUI management unit 121 may determine the input destination (transfer destination) of the voice command.

In S36, the first VUI function unit 122-1 executes the operation requested through the voice command on behalf of the second VUI function unit 122-2.

### Second Embodiment

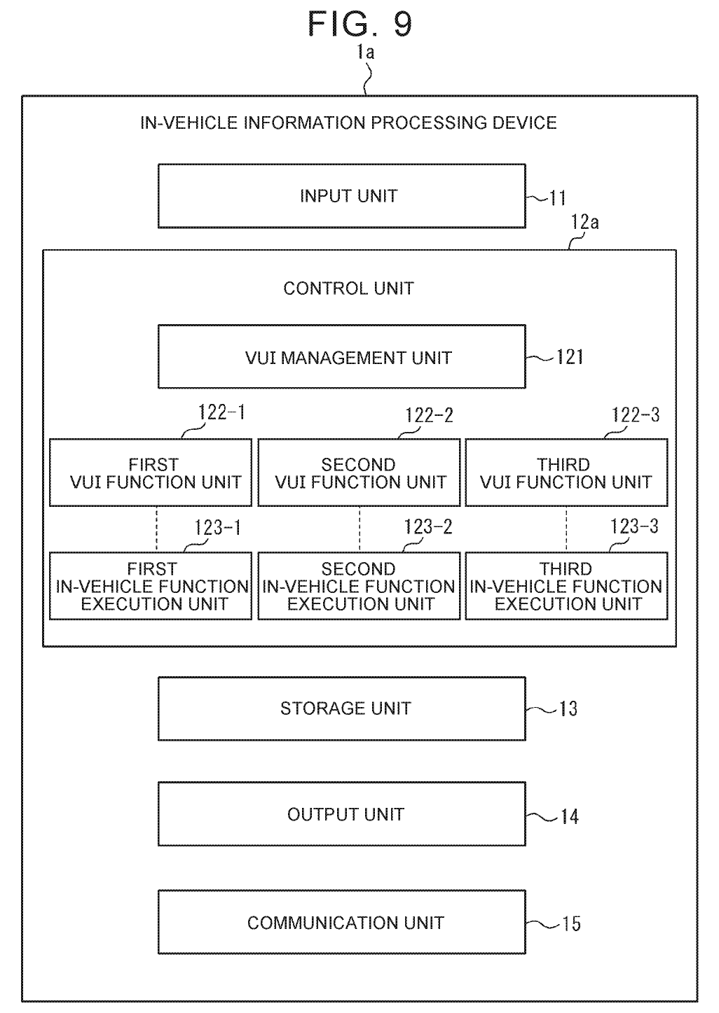

Next, an in-vehicle information processing device according to a second embodiment will be described. An in-vehicle information processing device 1a illustrated in FIG. 9 includes an input unit 11, a control unit 12a, a storage unit 13, an output unit 14, and a communication unit 15. The in-vehicle information processing device 1a is different from the in-vehicle information processing device 1 illustrated in FIG. 1 in the operation of the control unit 12a. The rest of the configuration is the same as that of the in-vehicle information processing device 1, and therefore the description will be omitted.

In the in-vehicle information processing device 1 illustrated in FIG. 1, the number N of VUIs is 2. The in-vehicle information processing device 1a is different from the in-vehicle information processing device 1 in that the number of VUIs N is 3. That is, the control unit 12a includes a VUI management unit 121, VUI function units 122-k (first VUI function unit 122-1, second VUI function unit 122-2, and third VUI function unit 122-3), and in-vehicle function execution units 123-k (first in-vehicle function execution unit 123-1, second in-vehicle function execution unit 123-2, and third in-vehicle function execution unit 123-3).

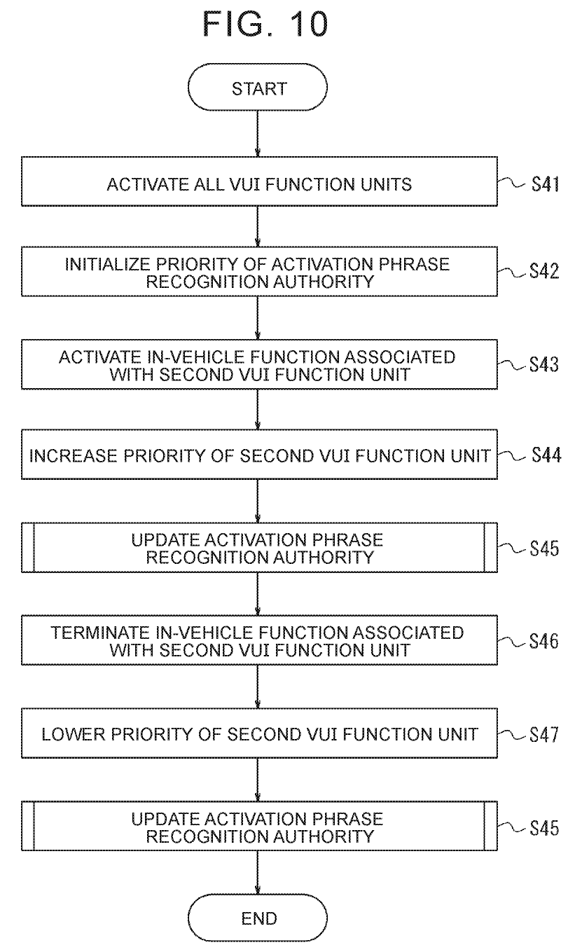

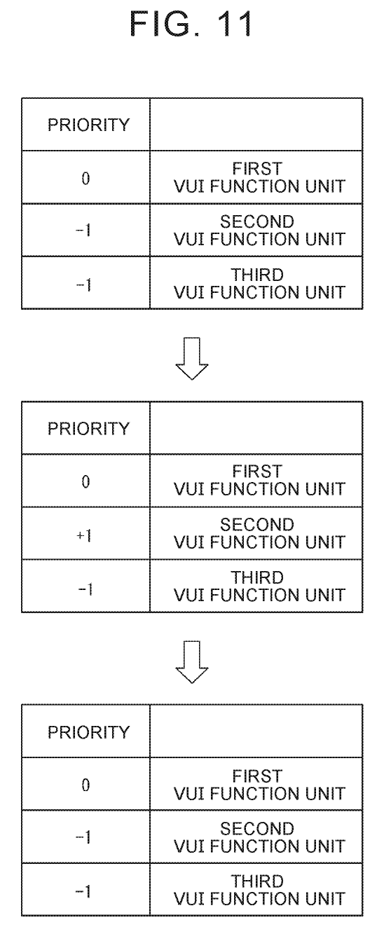

An example of the operation of the control unit 12a of the in-vehicle information processing device 1a according to the second embodiment will be described with reference to FIGS. 10 and 11. FIG. 10 is a flowchart illustrating an example of operation for a case where the user activates an in-vehicle function linked to the second VUI function unit 122-2 between the activation and the termination of the in-vehicle information processing device 1a. FIG. 11 illustrates the priority of the VUI function unit 122-k during the operation illustrated in FIG. 10.

In S41, when the in-vehicle information processing device 1a is activated, the VUI management unit 121 activates the first VUI function unit 122-1, the second VUI function unit 122-2, and the third VUI function unit 122-3.

In S42, the VUI management unit 121 initializes the priority of activation phrase recognition authority. For example, as indicated in FIG. 11, the priority of the first VUI function unit 122-1 is set to "0", the priority of the second VUI function unit 122-2 is set to "–1", and the priority of the third VUI function unit 122-3 is set to "–1". That is, in the example indicated in FIG. 11, the first VUI function unit 122-1 is given the highest priority at the time of initialization. The VUI management unit 121 also initializes the activation phrase recognition authority. Here, the following operation will be described on the assumption that the VUI management unit 121 has given the activation phrase recognition authority to the first VUI function unit 122-1.

In S43, it is assumed that the user of the in-vehicle information processing device 1a inputs an instruction to activate an in-vehicle function linked to the second VUI function unit 122-2 by operating the input unit 11. Then, the second in-vehicle function execution unit 123-2 activates the in-vehicle function based on the instruction by the user.

In S44, the VUI management unit 121 sets the priority of the second VUI function unit 122-2 to be higher than the priority of the first VUI function unit 122-1. For example, as indicated in FIG. 11, the priority of the second VUI function unit 122-2 is increased from "–1" to "+1".

In S45, the VUI management unit 121 updates the activation phrase recognition authority. The process in S45 is the same as the process in S15 illustrated in FIG. 4. In the example illustrated in FIGS. 10 and 11, at this point, the first VUI function unit 122-1 has been given the activation phrase recognition authority, and the second VUI function unit 122-2 has the highest priority (No in S151). Thus, the VUI management unit 121 revokes the activation phrase recognition authority from the first VUI function unit 122-1 (S152). Then, the VUI management unit 121 gives the activation phrase recognition authority to the second VUI function unit 122-2 with the highest priority (S153).

In S46, it is assumed that the user of the in-vehicle information processing device 1a inputs an instruction to terminate the in-vehicle function linked to the second VUI function unit 122-2 by operating the input unit 11. Then, the second in-vehicle function execution unit 123-2 terminates the in-vehicle function based on the instruction by the user.

In S47, the VUI management unit 121 sets the priority of the second VUI function unit 122-2 to be lower than the priority of the first VUI function unit 122-1. For example, as indicated in FIG. 11, the priority of the second VUI function unit 122-2 is lowered from "+1" to "–1."

After S47, the VUI management unit 121 performs the same process as in S45 (S15) again. In the example illustrated in FIGS. 10 and 11, at this point, the second VUI function unit 122-2 has been given the activation phrase recognition authority, and the first VUI function unit 122-1 has the highest priority (No in S151). Thus, the VUI management unit 121 revokes the activation phrase recognition authority from the second VUI function unit 122-2 (S152). Then, the VUI management unit 121 gives the activation phrase recognition authority to the first VUI function unit 122-1 with the highest priority (S153).

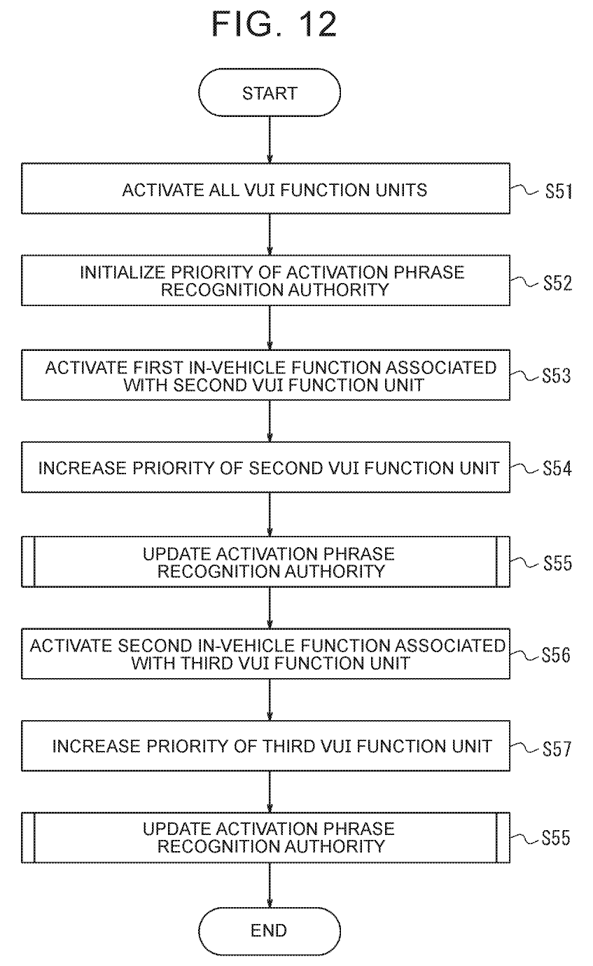

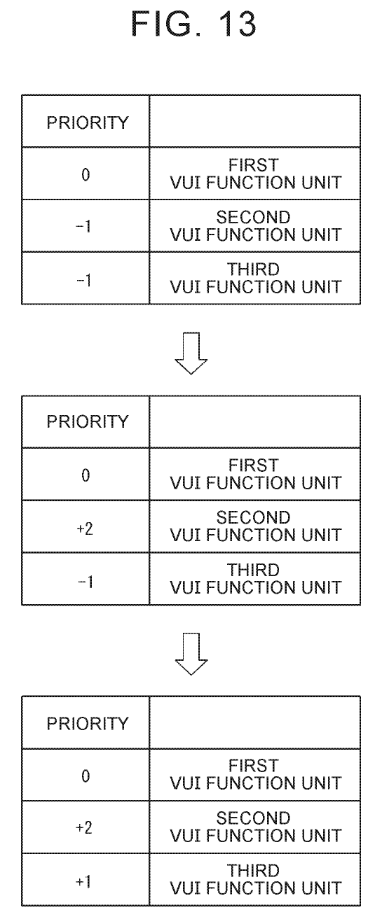

In FIG. 10, it is assumed that only one in-vehicle function linked to the second VUI function unit 122-2 is activated. However, a plurality of in-vehicle functions linked to different VUI function units 122-k may be activated at the same time. For example, as illustrated in FIG. 5, the in-vehicle function linked to the second VUI function unit 122-2 may be a navigation application, the in-vehicle function linked to the third VUI function unit 122-3 may be an audio application that plays audio in the background of the navigation application, and the navigation application and the audio application may be activated at the same time. Furthermore, the VUI management unit 121 may change the weight of the priority of the in-vehicle function. The process in this case will be described with reference to FIGS. 12 and 13.

FIG. 12 is a flowchart illustrating an example of operation for a case where the user activates an in-vehicle function linked to the second VUI function unit 122-2 and an in-vehicle function linked to the third VUI function unit 122-3 after the activation of the in-vehicle information processing device 1a. FIG. 13 illustrates the priority of the VUI function unit 122-k during the operation illustrated in FIG. 12.

In S51, when the in-vehicle information processing device 1a is activated, the VUI management unit 121 activates the first VUI function unit 122-1, the second VUI function unit 122-2, and the third VUI function unit 122-3.

In S52, the VUI management unit 121 initializes the priority of activation phrase recognition authority. For example, as indicated in FIG. 13, the priority of the first VUI function unit 122-1 is set to "0", the priority of the second VUI function unit 122-2 is set to "–1", and the priority of the third VUI function unit 122-3 is set to "–1". That is, in the example indicated in FIG. 13, the first VUI function unit 122-1 is given the highest priority at the time of initialization. The VUI management unit 121 also initializes the activation phrase recognition authority. Here, the following operation will be described on the assumption that the VUI management unit 121 has given the activation phrase recognition authority to the first VUI function unit 122-1.

In S53, it is assumed that the user of the in-vehicle information processing device 1a inputs an instruction to activate a first in-vehicle function (for example, a navigation application) linked to the second VUI function unit 122-2 by operating the input unit 11. Then, the second in-vehicle function execution unit 123-2 activates the first in-vehicle function based on the instruction by the user.

In S54, the VUI management unit 121 sets the priority of the second VUI function unit 122-2 to be higher than the priority of the first VUI function unit 122-1. For example, as indicated in FIG. 13, the priority of the second VUI function unit 122-2 is increased from "–1" to "+2".

In S55, the VUI management unit 121 updates the activation phrase recognition authority. The process in S45 is the same as the process in S15 illustrated in FIG. 4. In the example illustrated in FIGS. 12 and 13, at this point, the first VUI function unit 122-1 has been given the activation phrase recognition authority, and the second VUI function unit 122-2 has the highest priority (No in S151). Thus, the VUI management unit 121 revokes the activation phrase recognition authority from the first VUI function unit 122-1 (S152). Then, the VUI management unit 121 gives the activation phrase recognition authority to the second VUI function unit 122-2 with the highest priority (S153).

In S56, it is assumed that the user of the in-vehicle information processing device 1a inputs an instruction to activate a second in-vehicle function (for example, an audio application) linked to the third VUI function unit 122-3 by operating the input unit 11. Then, the third in-vehicle function execution unit 123-3 activates the second in-vehicle function based on the instruction by the user. Alternatively, when the user of the in-vehicle information processing device 1a makes an instruction to activate the first in-vehicle function linked to the second VUI function unit 122-2 (S43), the third in-vehicle function execution unit 123-3 may automatically activate the second in-vehicle function subsequent to the activation of the first in-vehicle function.

In S57, the VUI management unit 121 sets the priority of the third VUI function unit 122-3 to be high. For example, as indicated in FIG. 13, the priority of the third VUI function unit 122-3 is increased from "–1" to "+1".

After S57, the VUI management unit 121 performs the same process as in S55 (S15) again. In the example illustrated in FIGS. 12 and 13, at this point, the second VUI function unit 122-2 has been given the activation phrase recognition authority, and the second VUI function unit 122-2 has the highest priority (Yes in S151). Thus, the VUI management unit 121 maintains the activation phrase recognition authority being given to the second VUI function unit 122-2.

In the above embodiments, the number N of VUIs is 2 or 3. However, it is clear that similar processing can be performed when N is 4 or more. Furthermore, the present disclosure is not limited to the above operation examples. As described above, the plurality of VUI functions of the in-vehicle information processing device 1, 1a is activated with an identical activation phrase. Therefore, the user does not need to have the knowledge of combinations of activation phrases and VUI functions linked to the activation phrases, and there is no need to remember a plurality of activation phrases, making it possible to improve the operability of in-vehicle functions. Furthermore, the in-vehicle information processing device 1, 1a can be positively equipped with a large number of VUI functions. For example, in order to be able to support different languages in each country and region, the in-vehicle information processing device 1, 1a may be equipped with different VUI functions for each language, or may be equipped with VUI functions made by a vendor that specializes in that language. Furthermore, the VUI functions allow the user to operate various in-vehicle functions by voice without diverting the line of sight, improving safety during drive.

In addition, in the in-vehicle information processing device 1, 1a, when a predetermined in-vehicle function is activated, a VUI function linked to the in-vehicle function is activated, and even during the activation of the VUI function, other VUI functions perform predetermined operation. When a VUI function does not have the right of access to an operation requested through a voice command, the other VUI function can be operated, even during the activation of one VUI function, by inputting a voice command to the other VUI function. Therefore, the in-vehicle information processing device 1, 1a can improve the resource utilization efficiency compared to when each VUI function responds individually. For example, even when a VUI function linked to a first in-vehicle function (e.g., a navigation function) does not have the right of access to a second in-vehicle function (e.g., an air conditioning operation function), the user can give a voice instruction for the second in-vehicle function during the activation of the first in-vehicle function.

Furthermore, the in-vehicle information processing device 1, 1a updates activation phrase recognition authority by dynamically changing the priority of the activation phrase recognition authority using the activation and the termination of an in-vehicle function as a trigger. Therefore, the in-vehicle information processing device 1, 1a can suppress an increase in resource consumption caused by a plurality of in-vehicle functions being activated at the same time in response to an activation phrase.

### Program

A computer capable of executing program instructions can be used to function as the above in-vehicle information processing device 1, 1a. The program can cause the computer to function as the in-vehicle information processing device 1, 1a by causing the computer to execute the above operation.

The program can be stored in a non-transitory computer-readable medium. Examples of the non-transitory computer-readable medium include a flash memory, a magnetic recording device, an optical disc, a magneto-optical recording medium, and a ROM. The program is distributed by selling, transferring, or renting a portable medium such as a Secure Digital (SD) card, a Digital Versatile Disc (DVD), or a Compact Disc Read Only Memory (CD-ROM) in which the program is stored, for example. The program may be distributed by storing the program in a storage of a server and transferring the program from the server to other computers. The program may be provided as a program product.

The computer temporarily stores, in the storage unit 13, the program stored in the portable medium or the program transferred from the server, for example. The computer then reads the program stored in the storage unit 13 with a processor (control unit 12) and executes processing according to the read program with the processor. The processor may be a Central Processing Unit (CPU), a Micro Processing Unit (MPU), a System on a Chip (SoC), or the like, and may be composed of a plurality of processors of the same or different types.

The computer may read the program directly from the portable medium and execute processing according to the program. Each time the program is transferred from the server to the computer, the computer may successively execute processing according to the program that is received. Processing may be executed by a so-called Application Service Provider (ASP) type service, in which functions are implemented only by making execution instructions and acquiring results, without transferring a program from a server to a computer. The program includes information that is to be provided for processing by an electronic computer and that is equivalent to a program. For example, data that is not a direct command for the computer but that has the property of defining processing for the computer corresponds to information that is “equivalent to a program".

While the above embodiments have been described as typical examples, various modifications and changes may be made without departing from the spirit and scope of the present disclosure. For example, a plurality of component blocks or process steps described in the embodiments can be combined into one, or one component block or processing step can be divided into a plurality of component blocks or process steps.

Some embodiments of the present disclosure will be indicated below. However, it should be noted that the embodiments of the present disclosure are not limited to these.

### Appendix 1

An in-vehicle information processing device including a control unit, in which:

the control unit has a plurality of VUI functions to be activated with an identical activation phrase; the VUI functions are linked to respective in-vehicle functions; the VUI functions each perform a speech recognition process on an utterance by a user to recognize a voice command for an in-vehicle function and execute the in-vehicle function based on the voice command; and

when a predetermined in-vehicle function is activated, a VUI function linked to the in-vehicle function is activated and, even during activation of the VUI function, a different VUI function is allowed to perform predetermined operation.

### Appendix 2

An in-vehicle information processing device including a plurality of VUI functions to be activated with an identical activation phrase, in which

the VUI functions are linked to respective in-vehicle functions, and

when a predetermined in-vehicle function is activated, a VUI function linked to the in-vehicle function is activated and, even during activation of the VUI function, a different VUI function is allowed to perform predetermined operation.

### Appendix 3

The in-vehicle information processing device according to Appendix 1 or 2, in which when the VUI function does not have a right of access to an operation requested through a voice command, the voice command is input to the different VUI function.

### Appendix 4

The in-vehicle information processing device according to any one of Appendices 1 to 3, in which all of the VUI functions are activated when the in-vehicle information processing device is activated.

### Appendix 5

The in-vehicle information processing device according to any one of Appendices 1 to 4, in which when the predetermined in-vehicle function is activated, priority of activation phrase recognition authority of a VUI function linked to the in-vehicle function is increased.

### Appendix 6

The in-vehicle information processing device according to any one of Appendices 1 to 5, in which when the predetermined in-vehicle function is terminated, priority of activation phrase recognition authority of a VUI function linked to the in-vehicle function is lowered.

### Appendix 7

The in-vehicle information processing device according to any one of Appendices 1 to 6, in which when a VUI function that has been given activation phrase recognition authority does not have highest priority of the activation phrase recognition authority, the activation phrase recognition authority is revoked from the VUI function and the activation phrase recognition authority is given to a different VUI function with the highest priority.

### Appendix 8

The in-vehicle information processing device according to any one of Appendices 1 to 7, in which priority of activation phrase recognition authority of the VUI functions is initialized when the in-vehicle information processing device is activated.

### Appendix 9

An information processing method executed by an in-vehicle information processing device having a plurality of VUI functions to be activated with an identical activation phrase, in which: the VUI functions are linked to respective in-vehicle functions; and

the in-vehicle information processing device is configured to

perform a speech recognition process on an utterance by a user to recognize a voice command for an in-vehicle function and execute the in-vehicle function based on the voice command, and

when a predetermined in-vehicle function is activated, activate a VUI function linked to the in-vehicle function and, even during activation of the VUI function, allow a different VUI function to perform predetermined operation.

### Appendix 10

An information processing method executed by an in-vehicle information processing device having a plurality of VUI functions to be activated with an identical activation phrase, in which: the VUI functions are linked to respective in-vehicle functions; and

the in-vehicle information processing device is configured to

when a predetermined in-vehicle function is activated, activate a VUI function linked to the in-vehicle function and, even during activation of the VUI function, allow a different VUI

function to perform predetermined operation.

### Appendix 11

The information processing method according to Appendix 9 or 10, in which the in-vehicle information processing device is configured to

when the VUI function does not have a right of access to an operation requested through a voice command, input the voice command to the different VUI function.

### Appendix 12

The information processing method according to any one of Appendices 9 to 11, in which the in-vehicle information processing device is configured to

activate all of the VUI functions when the in-vehicle information processing device is activated.

### Appendix 13

The information processing method according to any one of Appendices 9 to 12, in which the in-vehicle information processing device is configured to

when the predetermined in-vehicle function is activated, increase priority of activation phrase recognition authority of a VUI function linked to the in-vehicle function.

### Appendix 14

The information processing method according to any one of Appendices 9 to 13, in which the in-vehicle information processing device is configured to

when the predetermined in-vehicle function is terminated, lower priority of activation phrase recognition authority of a VUI function linked to the in-vehicle function.

### Appendix 15

The information processing method according to any one of Appendices 9 to 14, in which the in-vehicle information processing device is configured to

when a VUI function that has been given activation phrase recognition authority does not have highest priority of the activation phrase recognition authority, revoke the activation phrase recognition authority from the VUI function and give the activation phrase recognition authority to a different VUI function with the highest priority.

### Appendix 16

The information processing method according to any one of Appendices 9 to 15, in which the in-vehicle information processing device is configured to

initialize priority of activation phrase recognition authority of the VUI functions when the

in-vehicle information processing device is activated.

### Appendix 17

A program to be executed by a computer that functions as an in-vehicle information processing device having a plurality of VUI functions to be activated with an identical activation phrase, in which:

the VUI functions are linked to respective in-vehicle functions; and

the program causes the computer to

perform a speech recognition process on an utterance by a user to recognize a voice command for an in-vehicle function and execute the in-vehicle function based on the voice command, and

when a predetermined in-vehicle function is activated, activate a VUI function linked to the in-vehicle function and, even during activation of the VUI function, allow a different VUI function to perform predetermined operation.

### Appendix 18

A program to be executed by a computer that functions as an in-vehicle information processing device having a plurality of VUI functions to be activated with an identical activation phrase, in which:

the VUI functions are linked to respective in-vehicle functions; and

the program causes the computer to

when a predetermined in-vehicle function is activated, activate a VUI function linked to the in-vehicle function and, even during activation of the VUI function, allow a different VUI function to perform predetermined operation.

### Appendix 19

The program according to Appendix 17 or 18, in which the program causes the computer to

when the VUI function does not have a right of access to an operation requested through a voice command, input the voice command to the different VUI function.

### Appendix 20

The program according to any one of Appendices 17 to 19, in which the program causes the computer to

when the predetermined in-vehicle function is activated, increase priority of activation phrase recognition authority of a VUI function linked to the in-vehicle function.

What is claimed is:

1. An in-vehicle information processing device comprising
a processor configured to:
activate a plurality of VUI functions with an identical activation phrase, the VUI functions being linked to respective in-vehicle functions; and
in a case where a predetermined in-vehicle function is activated, activate a VUI function linked to the in-vehicle function and allow a different VUI function to perform predetermined operation even during activation of the VUI function.

2. The in-vehicle information processing device according to claim 1, wherein the processor is configured to, in a case where the VUI function does not have a right of access to an operation requested through a voice command, input the voice command to the different VUI function.

3. The in-vehicle information processing device according to claim 1, wherein the processor is configured to activate all of the VUI functions in a case where the in-vehicle information processing device is activated.

4. The in-vehicle information processing device according to claim 1, wherein the processor is configured to, in a case where the predetermined in-vehicle function is activated, increase priority of activation phrase recognition authority of a VUI function linked to the in-vehicle function.

5. The in-vehicle information processing device according to claim 1, wherein the processor is configured to, in a case where the predetermined in-vehicle function is terminated, lower priority of activation phrase recognition authority of a VUI function linked to the in-vehicle function.

6. The in-vehicle information processing device according to claim 1, wherein the processor is configured to, in a case where a VUI function that has been given activation phrase recognition authority does not have highest priority of the activation phrase recognition authority, revoke the activation phrase recognition authority from the VUI function and give the activation phrase recognition authority to a different VUI function with the highest priority.

7. The in-vehicle information processing device according to claim 1, wherein the processor is configured to initialize priority of activation phrase recognition authority of the VUI functions in a case where the in-vehicle information processing device is activated.

8. An information processing method executed by an in-vehicle information processing device having a plurality of VUI functions to be activated with an identical activation phrase, the VUI functions being linked to respective in-vehicle functions, the information processing method comprising, in a case where a predetermined in-vehicle function is activated, activating a VUI function linked to the in-vehicle function and, even during activation of the VUI function, allowing a different VUI function to perform predetermined operation.

9. The information processing method according to claim 8, further comprising, in a case where the VUI function does not have a right of access to an operation requested through a voice command, inputting the voice command to the different VUI function.

10. The information processing method according to claim 8, further comprising activating all of the VUI functions in a case where the in-vehicle information processing device is activated.

11. The information processing method according to claim 8, further comprising, in a case where the predetermined in-vehicle function is activated, increasing priority of activation phrase recognition authority of a VUI function linked to the in-vehicle function.

12. The information processing method according to claim 8, further comprising, in a case where the predetermined in-vehicle function is terminated, lowering priority of activation phrase recognition authority of a VUI function linked to the in-vehicle function.

13. The information processing method according to claim 8, further comprising, in a case where a VUI function that has been given activation phrase recognition authority does not have highest priority of the activation phrase recognition authority, revoking the activation phrase recognition authority from the VUI function and giving the activation phrase recognition authority to a different VUI function with the highest priority.

14. The information processing method according to claim 8, further comprising initializing priority of activation phrase recognition authority of the VUI functions in a case where the in-vehicle information processing device is activated.

15. A non-transitory storage medium storing instructions that are executable by one or more processors and cause the one or more processors to execute a function, the processors having a plurality of VUI functions to be activated with an identical activation phrase, and the VUI functions being linked to respective in-vehicle functions, the function comprising, in a case where a predetermined in-vehicle function is activated, activating a VUI function linked to the in-vehicle function and, even during activation of the VUI function, allowing a different VUI function to perform predetermined operation.

16. The non-transitory storage medium according to claim 15, wherein the function further comprises, in a case where the VUI function does not have a right of access to an operation requested through a voice command, inputting the voice command to the different VUI function.

17. The non-transitory storage medium according to claim 15, wherein the function further comprises, in a case where the predetermined in-vehicle function is activated, increasing priority of activation phrase recognition authority of a VUI function linked to the in-vehicle function.
